(19) United States
(12) Patent Application Publication
(10) Pub. No.: US 2008/0318646 A1
(43) Pub. Date: Dec. 25, 2008

(54) MOBILE PHONES

(75) Inventor: Yi-Ching LIN, Taipei City (TW)

Correspondence Address: QUINTERO LAW OFFICE, PC, 2210 MAIN STREET, SUITE 200, SANTA MONICA, CA, 90405, US

(73) Assignee: QISDA CORPORATION, Taoyuan County (TW)

(21) Appl. No.: 12/137,387

(22) Filed: Jun. 11, 2008

(30) Foreign Application Priority Data
Jun. 22, 2007 (TW) TW96122498

(51) Int. Cl. H04M 1/00

(52) U.S. Cl. 455/575.4

(57) ABSTRACT

Mobile phones are provided. A mobile phone comprises a housing, a battery cover, a joining member, and a slider. The battery cover is detachably connected to the housing for covering a battery of the mobile phone. The joining member is movably disposed on the housing and detachably joined with the battery cover. The slider movably connects to the joining member and includes a hole. When the slider is in a first position, the hole is situated outside the housing. When the slider moves with respect to the joining member from the first position to a second position, the hole is concealed in the housing.

### BACKGROUND OF THE INVENTION

1. Field of the Invention

The invention relates in general to mobile phones and in particular to mobile phones capable of having straps tied thereto.

2. Description of the Related Art

Referring to FIG. 1, a conventional mobile phone usually comprises a housing M with an arm C formed in a corner thereof for attachment of a strap (not shown). As shown in FIG. 1, two openings H are communicated adjacent to the arm C. For attachment of the strap to the arm C, the strap is inserted through the openings H and knotted. Here, the arm C and the openings H are fixed structures exposed on the housing M, inevitably deteriorating clear and integral appearance of the mobile phone.

### BRIEF SUMMARY OF THE INVENTION

Mobile phones are provided. A mobile phone comprises a housing, a battery cover, a joining member, and a slider. The battery cover is detachably connected to the housing for covering a battery of the mobile phone. The joining member is movably disposed on the housing. The slider movably connects to the joining member and includes a hole. When the slider is in a first position, the hole is situated outside the housing. When the slider moves with respect to the joining member from the first position to a second position, the hole is concealed in the housing.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional mobile phone;

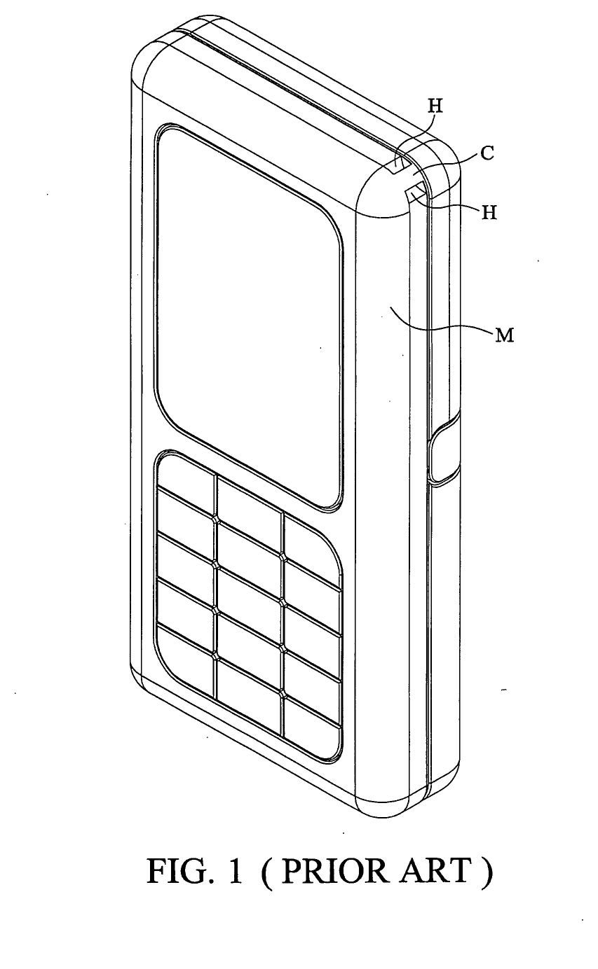

FIG. 2 is an exploded diagram of a mobile phone according to an embodiment of the invention;

FIG. 3 is a perspective diagram of a joining member of a mobile phone pressed by an external force according to an embodiment of the invention;

FIG. 4 is a perspective diagram of a battery cover separated from a housing of the mobile phone according to an embodiment of the invention;

FIG. 5 is a perspective diagram of a strap hole of a slider situated outside a housing of a mobile phone according to an embodiment of the invention; and

FIG. 6 is a perspective diagram of a strap hole of a slider concealed in a housing of a mobile phone according to an embodiment of the invention;

FIG. 7 is an exploded diagram a push-push type mechanism according to an embodiment of the invention;

FIG. 8 is a perspective diagram of the push-push type mechanism in FIG. 7;

FIG. 9 is a top view of the push-push type mechanism in FIG. 8; and

FIG. 10 is a perspective diagram of a second end of a guide pin moving around a restricting portion.

### DETAILED DESCRIPTION OF THE INVENTION

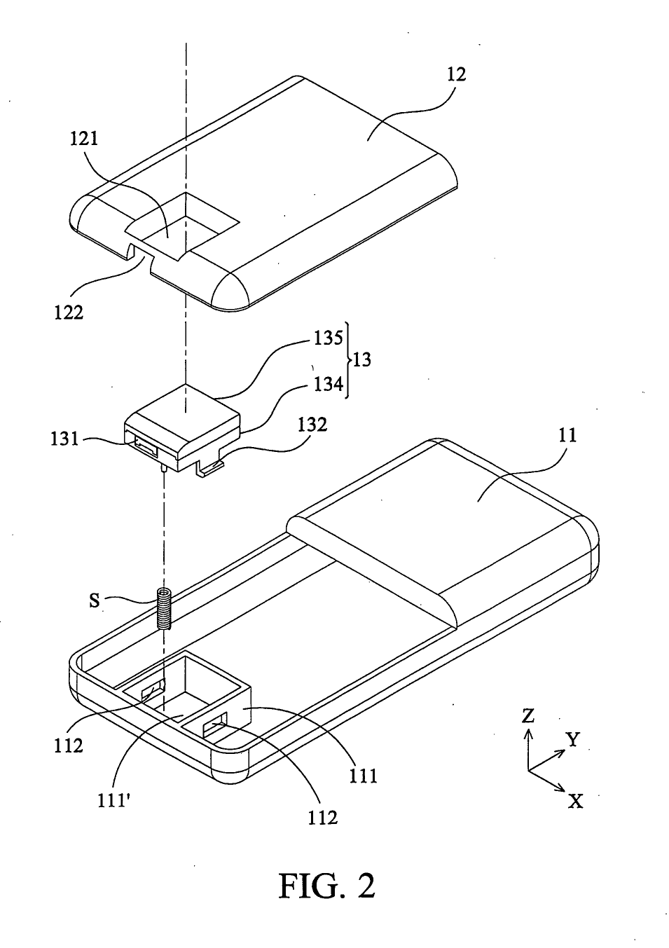

Referring to FIG. 2, an embodiment of a mobile phone primarily comprises a housing 11, a battery cover 12, a joining member 13, and a resilient member S. The battery cover 12 is detachably connected to the housing 11 for covering a battery (not shown) of the mobile phone. As shown in FIG. 2, the housing 11 comprises a holder 111 having a rectangular receiving space 111′ and two slots 112 formed on opposite side walls thereof. The joining member 13 includes a main body 134 and a lid 135 coupled with the main body 134. During assembly, the joining member 13 is disposed in the receiving space 111′, and two hooks 132 thereof are joined in the slots 112, preventing the joining member 13 to separate from the receiving space 111′.

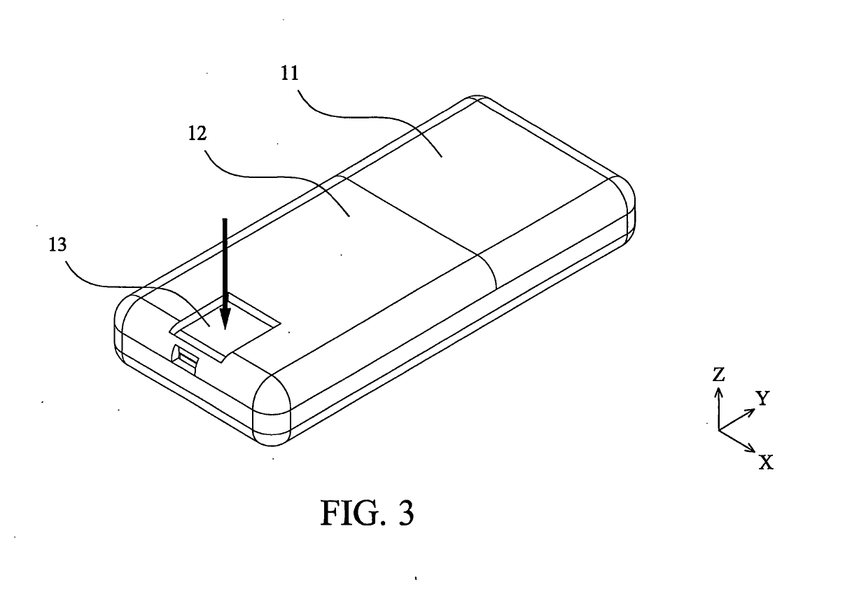

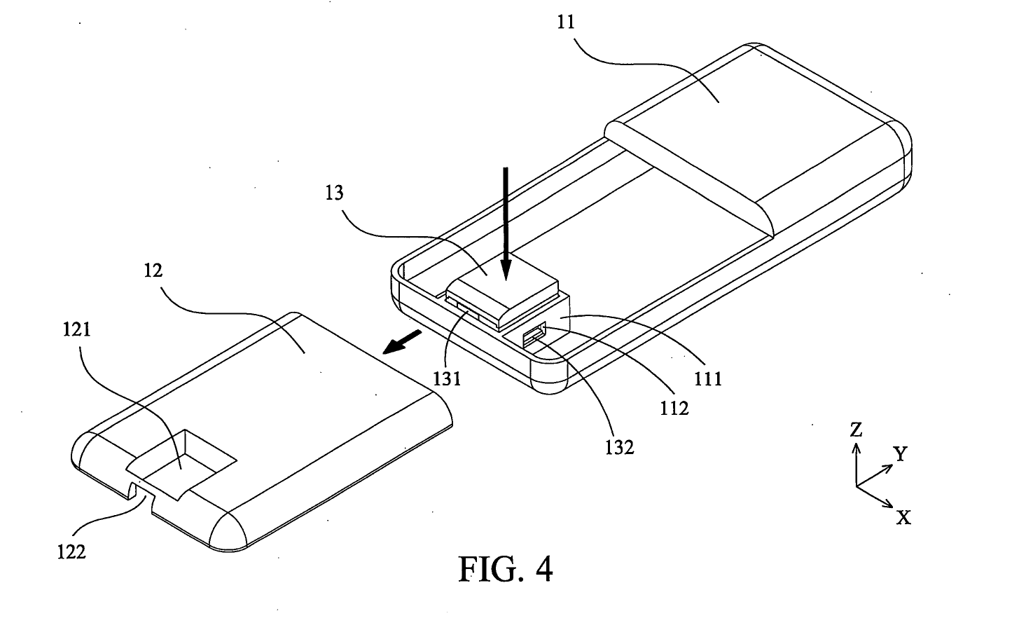

In this embodiment, dimension of the slots 112 along Z direction exceed that of the hooks 132, such that the hooks 132 are movable within the slots 112, respectively. The resilient member S, such as a compression spring, is disposed in the receiving space 111′ and contacts the joining member 13 and the bottom of the holder 111, thus exerting a spring force upwardly on the joining member 13. When the battery cover 12 is coupled with the housing 11, the joining member 13 is joined in an opening 121 of the battery cover 12, wherein the spring force from the resilient member S can facilitate robust connection and prevent separation therebetween. Referring to FIGS. 3 and 4, when replacing the battery, the joining member 13 is pressed by an external force (FIG. 3) and released from the opening 121, such that the battery cover 12 is removed from the housing 11 (FIG. 4).

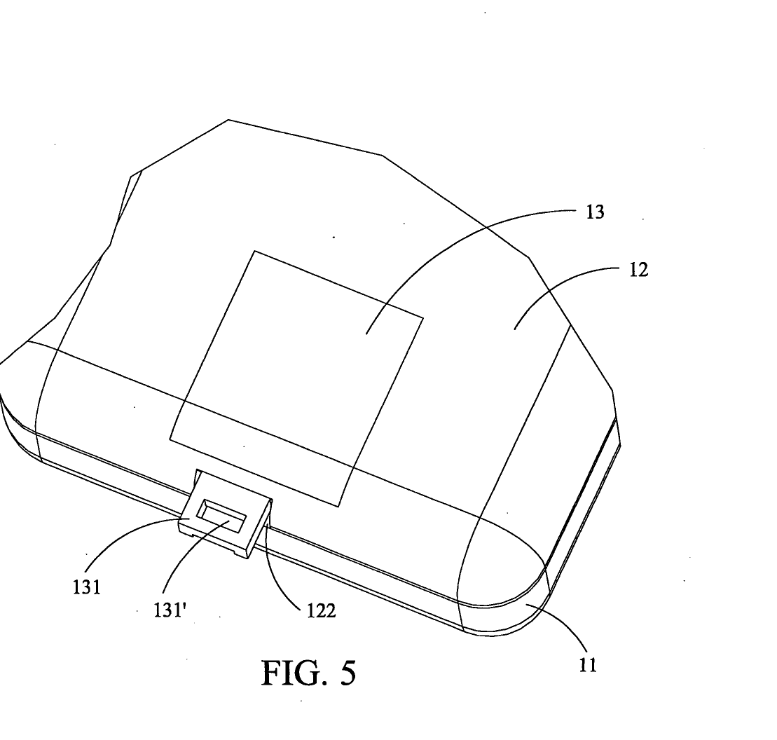

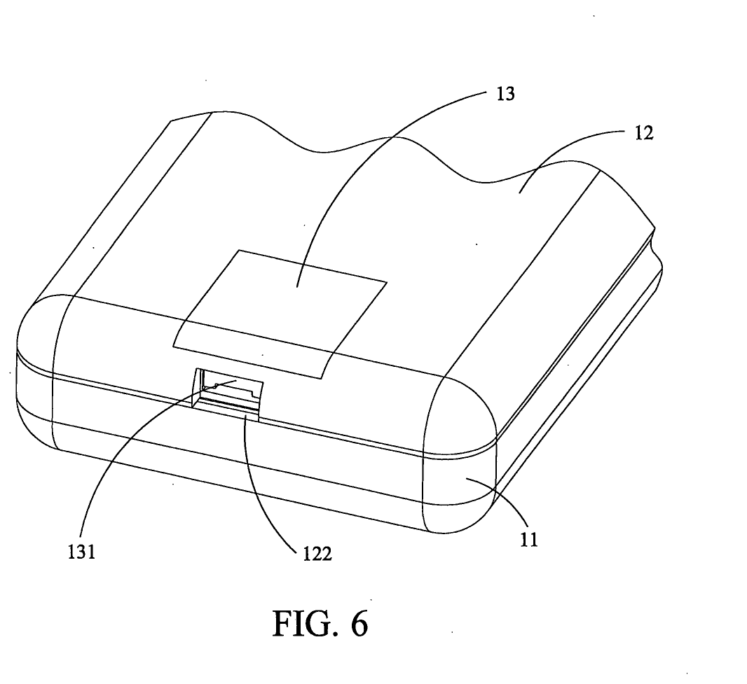

As shown in FIG. 5, the joining member 13 further comprises a slider 131 movable along Y axis. When replacing or tying a strap, the slider 131 is drawn from the interior of the joining member 13 to a first position. When in the first position, the slider 131 extends through a recess 122 of the battery cover 12 and projects from the housing 11, such that the strap can be tied to the slider 131 through a strap hole 131′ thereof. With the strap tied to the slider 131, the slider 131 is pushed to a second position, as shown in FIG. 6, such that the slider 131 and the strap hole 131′ are concealed in the joining member 13, thus, allowing an integral appearance of the mobile phone.

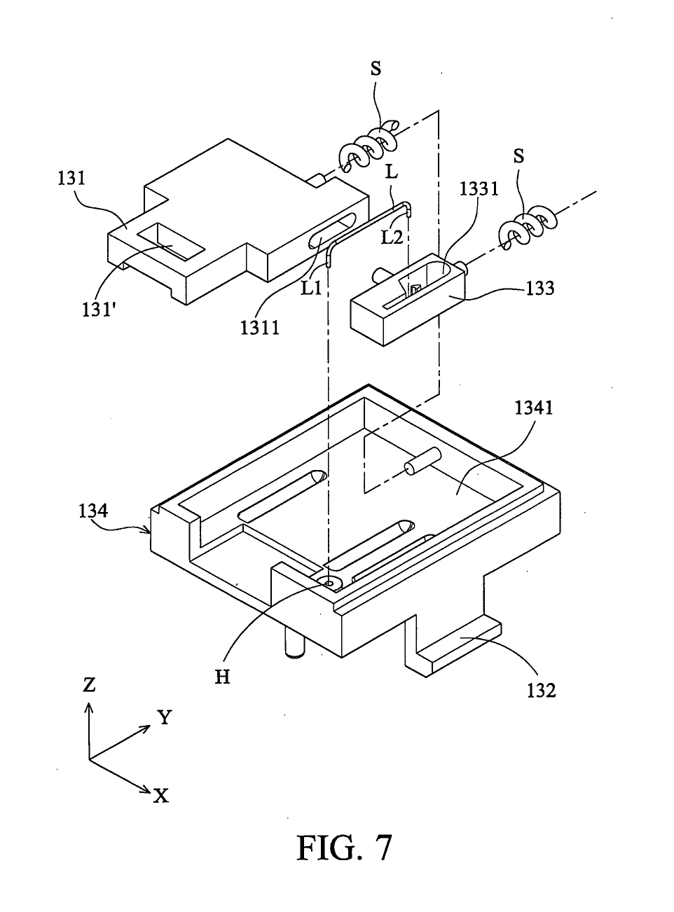

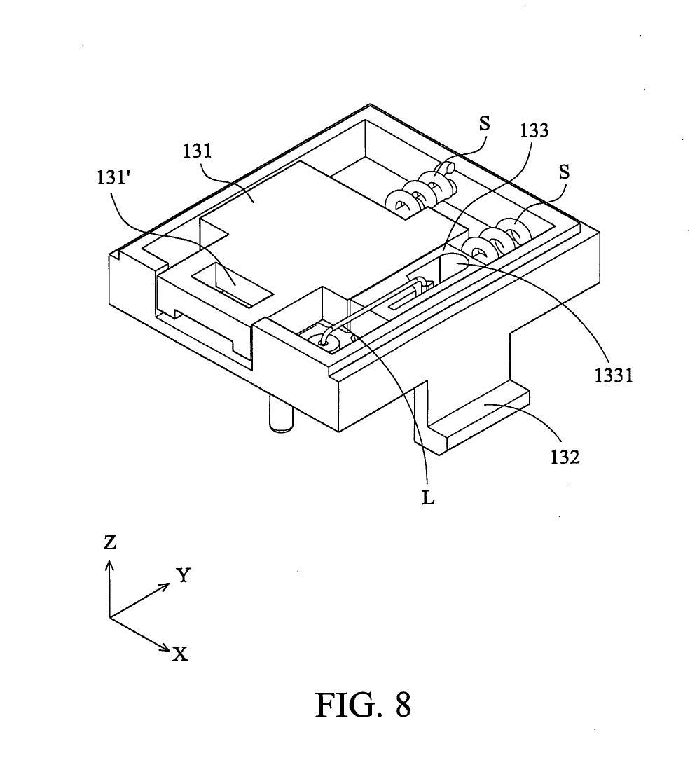

In some embodiments, a push-push type mechanism is provided to couple the slider 131 with the joining member 13. Users can alternatively draw out or return the slider 131 into the joining member 13 by repeatedly pushing the slider 131, facilitating convenience of usage. As shown in FIGS. 7 and 8, an exemplary embodiment of the slider 131 is coupled and moved along with a guiding device 133, wherein the slider 131 and the guiding device 133 are received in a recess 1341 of the main body 134 of the joining member 13. Here, the guiding device 133 is movably connected to a slot 1311 of the slider 131, and the slider 131 and the guiding device 133 connect to a sidewall of the main body 134 via two springs S, respectively.

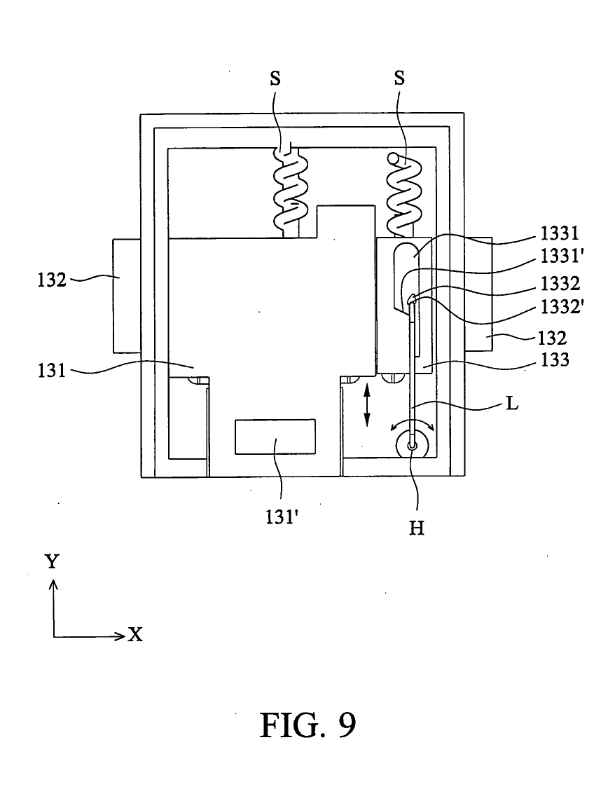

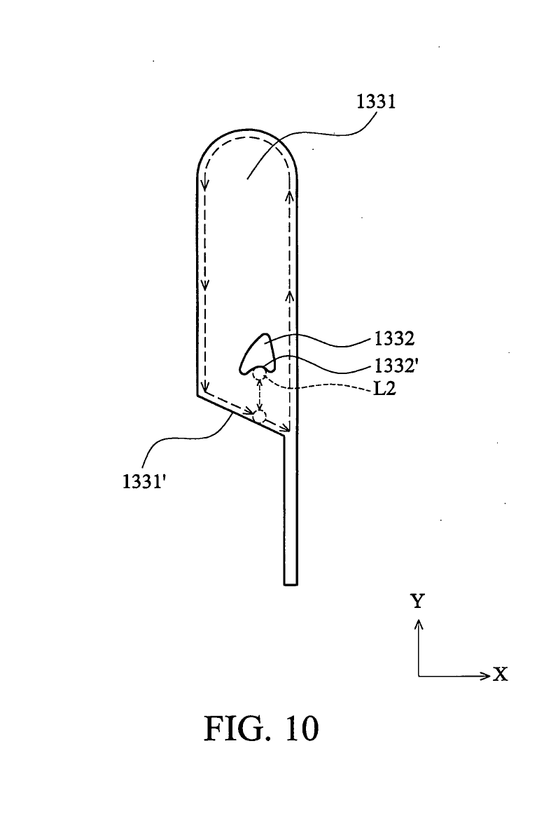

Referring to FIGS. 7˜9, an U-shaped guide pin L has a first end L1 and a second end L2, wherein the first end L1 is pivotally connected to a hole H of the main body 134, and the second end L2 is disposed in a groove 1331 of the guiding device 133. As shown in FIGS. 9 and 10, the guiding device 133 has a restricting portion 1332 disposed in the groove 1331. When the slider 131 is in the second position, the second end L2 of the guide pin L is restricted in a notch 1332′ of the restricting portion 1332. When the slider 131 is pushed and reciprocally slides with respect to the main body 134 from the second position to the first position along Y axis, as the arrows indicate in FIG. 9, the second end L2 releases from the notch 1332′ and slides along a slope 1331′ of the groove 1331 to revolve around the restricting portion 1332 (FIG. 10). In this embodiment, the guiding device 133, the guide pin L, the springs S, and the main body 134 of the joining member 13 comprises a push-push type mechanism to facilitate reciprocal motion of the slider 131. It is noted that various push-push type mechanisms can be applied to the mobile phone for the reciprocal motion of the slider 131.

Mobile phones are provided according to the embodiments. The mobile phone comprises a slider having a strap hole. The slider and the strap hole can be concealed in the mobile phone, facilitating an integral appearance thereof.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A mobile phone, comprising:
a housing;
a battery cover detachably connected to the housing for covering a battery of the mobile phone;
a joining member movably disposed on the housing; and
a slider, movably connecting to the joining member, including a hole, wherein the hole is situated outside the housing when the slider is in a first position, and the hole is concealed in the housing when the slider moves with respect to the joining member from the first position to a second position.

2. The mobile phone of claim 1, wherein the battery cover comprises a recess, and the slider extends through the recess and projects from the housing when the slider is in the first position.

3. The mobile phone of claim 1, further comprising a push-push type mechanism coupling the joining member with the slider, to impel the slider between the first and second positions.

4. The mobile phone of claim 1, wherein the housing comprises a holder forming a receiving space with the joining member accommodated therein.

5. The mobile phone of claim 4, wherein the receiving space of the holder is substantially rectangular.

6. The mobile phone of claim 4, wherein the holder further comprises a slot, and the joining member comprises a hook joining the slot to restrict the joining member within the receiving space.

7. The mobile phone of claim 6, wherein dimensions of the slot exceed that of the hook, such that the hook is movable within the slot along a first axis.

8. The mobile phone of claim 7, further comprising a resilient member disposed in the receiving space and connected to the joining member, exerting a spring force on the joining member along the first axis.

9. The mobile phone of claim 8, wherein the resilient member is a compression spring.

10. The mobile phone of claim 8, wherein the slider is movable substantially perpendicular to the first axis.

11. The mobile phone of claim 8, wherein the battery cover comprises an opening, and the resilient member pushes the joining member to join the opening, such that the battery cover is fixed to the housing.

12. The mobile phone of claim 11, wherein when the joining member is pressed by an external force and separated from the opening, the battery cover is released from the housing.

13. The mobile phone of claim 1, wherein the joining member further comprises:
a guiding device connected to the slider and moved along with the slider; and
a guide pin including a first end connected to the joining member and a second end movably disposed in the guiding device.

14. The mobile phone of claim 13, wherein the guiding device comprises a restricting portion and a slope, and when the slider is in the second position, the second end of the guide pin is engaged with the restricting portion, and when the slider moves with respect to the joining member from the second position to the first position, the second end disengages from the restricting portion and slides along the slope.

15. The mobile phone of claim 14, wherein the restricting portion includes a notch, and when the slider is in the second position, the second end of the guide pin is engaged in the notch.

16. The mobile phone of claim 1, wherein the slider is disposed in the joining member.

17. The mobile phone of claim 1, wherein the hole is a strap hole.
